(19) United States
(12) Patent Application Publication
(10) Pub. No.: US 2008/0017821 A1
(43) Pub. Date: Jan. 24, 2008

(54) Adaptive pressure manifold

(75) Inventors: Jonathan S. Orban, Brisbane, CA (US); Carroll L. Price, Modesto, CA (US)

Correspondence Address: KOKKA & BACKUS, PC, 200 PAGE MILL ROAD, SUITE 103, PALO ALTO, CA, 94306, US

(73) Assignee: OE2, Inc., Brisbane, CA (US)

(21) Appl. No.: 11/491,792

(22) Filed: Jul. 24, 2006

(51) Int. Cl. F16L 37/28

(52) U.S. Cl. 251/149.6

(57) ABSTRACT

An adaptive pressure manifold is described, including a body having an inlet adapted to receive a pressurized gas container at a proximal end of the body, wherein a passage provides fluid communication between the inlet and an outlet located on a distal end of the body, a rotatable element coupled to the distal end of the body, the rotatable element having a groove disposed about the circumference of the rotatable element and substantially orthogonal to an axis of the rotatable element, the groove being configured to receive a gasket, and an end gasket disposed between a distal end of the rotatable element and a cup gasket, the cup gasket and the end gasket being secured to the rotatable element by a nozzle having a plurality of threads disposed at a proximal end, the proximal end being secured within the outlet using the plurality of threads.

### FIELD OF THE INVENTION

The present invention relates to portable fuel systems and, more specifically, to an adaptive pressure manifold.

### BACKGROUND

Pressurized fuel systems may be used for a variety of activities, including hiking, camping, mountaineering, climbing, and others. Conventional pressurized fuel systems may be used to supply fuel to camp stoves, lanterns, lamps, heaters, and other equipment. Fuel bottles, heat sources (e.g., a flame or light used in stoves, lanterns, lamps, heaters, and the like), and fuel supply assemblies (e.g., plungers or other pressurization devices) are often coupled and deployed together. Small, compact, and lightweight pressurized fuel systems are widely used in recreational, commercial, and military settings. However, conventional pressurized fuel systems are problematic and often dangerous.

Some conventional pressurized fuel systems rely upon the manual use of a piston or plunger to pressurize a fuel container, bottle, cylinder, holder, receptacle, or tank (hereafter “fuel container”) to enable fuel to flow to a heat source. Manual pressurization systems are often used to avoid the need to carry heavier equipment such as motorized pumps and compressors. Conventional pressurized fuel systems are often designed for use in various types of terrain due to small, compact, and lightweight components. When deployed, conventional pressurized fuel systems may be used to provide cooking, heating, and lighting capabilities. However, as pressure diminishes in conventional systems (i.e., as pressurized fuel flows from a fuel container), repeated manual operation of a plunger or piston is often required to increase pressure and continue a steady flow of fuel. Thus conventional techniques are operationally inefficient. Further, manual pressurization may be required frequently, depending upon altitude (i.e., barometric pressure), temperature, and other environmental factors. When coupled to an operational (i.e., a heat source is receiving a pressurized fuel supply) heat source, manually pumping a fuel container may be dangerous, unstable, and create a risk of bringing a pressurized fuel container or exposed body part into contact with a heat source. This may result in burns and other injuries or damage to property as a result of a fire or explosion. Further, as pressure dwindles within a fuel container, the flow of fuel also decreases until the active heat source or heating element ceases functioning or loses heating/cooking capabilities.

Thus, what is required is a solution for pressuring fuel systems without the limitations of conventional techniques.

### BRIEF DESCRIPTION OF THE DRAWINGS

The present invention will be readily understood by the following detailed description in conjunction with the accompanying drawings, and like reference numerals designate like structural elements.

FIG. 1A illustrates a side view of an exemplary adaptive pressure manifold;

FIG. 1B illustrates a frontal view of an exemplary adaptive pressure manifold;

FIG. 2 illustrates a side view of an alternative exemplary adaptive pressure manifold;

FIG. 3 illustrates another side view of an exemplary adaptive pressure manifold coupled to a pressurized gas container; and

FIG. 4 illustrates a side view of an exemplary adaptive pressurized fuel system.

### DETAILED DESCRIPTION

Embodiments or examples of the invention may be implemented in numerous ways, including as an apparatus, system, or process. A detailed description of one or more examples is provided below along with accompanying figures. The detailed description is provided in connection with such examples, but is not limited to any particular example. The scope is limited by the claims, but numerous alternatives, modifications, and equivalents are encompassed. Numerous specific details are set forth in the following description in order to provide a thorough understanding. These details are provided for the purpose of example and the descriptions provided may be used for implementation according to the claims without some or all of these specific details. For the purpose of clarity, technical material that is known in the technical fields related to the examples has not been described in detail to avoid unnecessarily obscuring the description.

An adaptive pressure manifold is described, which may be used to pressurize a fuel system to enable a flow of fuel from a pressurized fuel container to a heat source. In some examples, an adaptive pressure manifold may include a body coupled to a proximal end of a rotatable element, with one or more gaskets mounted circumferentially about the rotatable element. At a distal end of the rotatable element, an end gasket and a cup gasket are secured to the distal end of the rotatable element using a nozzle. The nozzle may be threaded at a proximal end and inserted into an outlet of the body. When rotated, the threaded proximal end of the nozzle engages threads on the internal surface of the outlet providing both a secure and air, gas, or fluid-tight seal (“seal”) to prevent gas from egressing other than at the distal end of the nozzle. In other examples, when a pressurized gas cylinder or container (“container”) containing an inert gas (e.g., carbon dioxide (CO₂), helium, and the like) is coupled to an inlet in the proximal end of the body, a piercing needle may be used to release the gas into a passage, channel, or lumen (“passage”) within the body. The passage provides a fluid or gas communication path for gas to flow from the pressurized container to the nozzle, passing from the adaptive manifold pressure and into, for example, a fuel bottle, cylinder, or container (“fuel container”). The adaptive pressure manifold provides gas pressure raised above atmospheric pressure levels at various altitudes to a fuel cylinder, thus providing a motive force to cause fuel flow to occur from a fuel container to a heat source without requiring manual operation or intervention of a pressure pump, which avoids any unstable activities or dangerous motion that could bring the fuel container into contact or proximity with a heat source or flame. Further, the adaptive pressure manifold may be removed from a fuel container after providing inert gas pressure to enable fuel flow to occur. Various alternative implementations and modifications to the examples provided may be used and are not limited to the descriptions, dimensions, or other exemplary details provided herein.

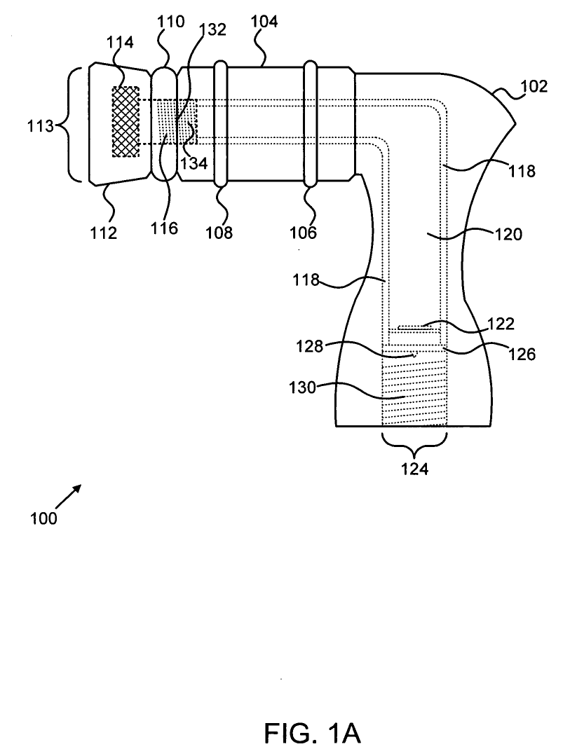

FIG. 1A illustrates a side view of an exemplary adaptive pressure manifold. Here, adaptive pressure manifold 100 includes body 102, rotatable element 104, gaskets 106-108, end gasket 110, cup gasket 112, nozzle 114, nozzle threads 116, passage walls 118, passage 120, one-way check valve 122, inlet 124, inlet gasket 126, piercing needle 128, inlet threads 130, outlet 132, and outlet threads 134. In some examples, body 102 may be coupled to rotatable element 104 using a variety of techniques. Clamps, screws, nuts, bolts, grips, hasps, latches, or other securing implementations may be used to couple rotatable element 104 to ensure rotational ability about a lateral axis. Further, rotatable element 104 may rotate freely in a clockwise or counterclockwise direction. The surface of rotatable element 104 may be smooth or have a grip-enhancing surface, such as grooves, trenches, or other surface contours that enable secure and firm gripping (i.e., with finger tips). In some examples, a smooth surface of rotatable element 104 may be implemented to enhance a seal formed between rotatable element 104 and a channel into which rotatable element 104 may be inserted.

Several elements of adaptive pressure manifold 100 may be used to create a seal between adaptive pressure manifold 100, a pressurized gas container (not shown) coupled to inlet 124, and a fuel container (not shown). Here, one or more circumferential grooves may be formed on the surface of rotatable element 104. Within each circumferential groove, gasket 106 may be inserted. Circumferential grooves may be configured, etched, lathed, machined, or otherwise formed in the surface of rotatable element 104. Circumferential grooves may be formed orthogonally to a lateral axis of rotatable element 104. In some examples, circumferential grooves may be formed to a depth that is less than the diameter of gaskets 106-108, thus permitting a portion of gaskets 106-108 to extend above the surface of rotatable element 104. Thus, when inserted into a fuel container, gaskets 106-108 may engage the inner surface of a channel of the fuel container. When engaged, gaskets 106-108 may also partially depress (i.e., depressing towards, but not completely flush with the surface of rotatable element 104) and create a seal around the outer circumference of rotatable element 104. When adaptive pressure manifold 100 is inserted into a channel (not shown), other elements may be used or implemented to form a seal.

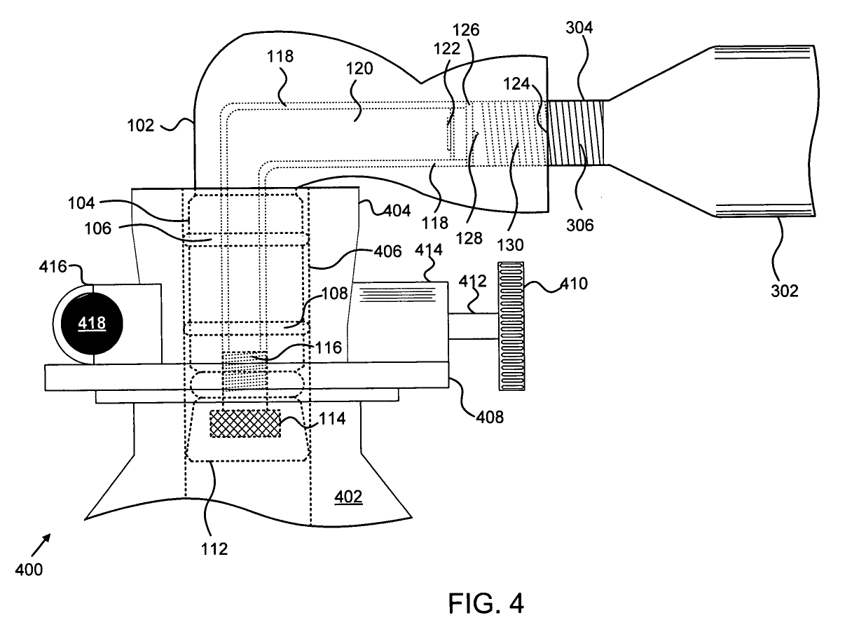

In some examples, end gasket 110 and cup gasket 112 may be used to also form a seal between the outer surface of rotatable element 104 and another surface (i.e., a channel into which adaptive pressure manifold 100 is inserted). End gasket 110 may have an overall diameter that is substantially equal to that of gaskets 106-108, thus ensuring that end gasket 110 also engages a surface surrounding rotatable element 104. Likewise, cup gasket 112 may be used to form a seal. In some examples, cup gasket 112 may have a proximal end or base with a first diameter that is smaller than cup gasket mouth 113 located at a distal end of cup gasket 112. Further, when pressurized gas is dispensed from nozzle 114, cup gasket mouth 113 directs the gas outward and also forms a seal with a surface surrounding cup gasket 112, thus preventing dispenses gas from flowing back over the outer surfaces of cup gasket 112, end gasket 110, rotatable element 104, and body 102. In some examples, end gasket 110 and cup gasket 112 may be secured to outlet 132 engaging nozzle threads 116 with inlet threads 134 to provide a sealed coupling between nozzle 114 and rotatable element 104. In other words, engaging nozzle threads 116 with inlet threads 134 ensures a contiguous, sealed channel from passage 120 through nozzle 114. Here, cup gasket 112, end gasket 110, and gaskets 106-108 form a multi-layered seal to prevent the unwanted escape of pressurized gas released from a pressurized gas container coupled to inlet 124, channeled through one-way check valve 122 into passage 120 and outwards through nozzle 114 and into a fuel container having a check valve (not shown) to prevent the escape of pressurized, inert gases when adaptive pressure manifold 100 is removed from the neck or insertion channel of a fuel container, as described in greater detail below in connection with FIG. 4. Referring back to FIG. 1A, passage 120 between inlet 124 and outlet 132 may be implemented differently and are not limited to the examples provided.

Here, gaskets 106-108, end gasket 110, and cup gasket mouth 113 may have overall diameters of ⅝″ and rotatable element 104 may have a 19/32″ diameter. Gaskets 106-108, end gasket 110, and cup gasket 112 may be formed of various materials and are not limited to any specific type of material. In some examples, one or more of gaskets 106-08, end gasket 110, and cup gasket 112 may be formed using rubber or rubber-based materials. In other examples, one or more of gaskets 106-108, end gasket 110, and cup gasket 112 may be formed using plastic or plastic-based materials. In still other examples, natural, composite, or other types of materials may be used to implement one or more of gaskets 106-108, end gasket 110, and cup gasket 112. Here, gaskets 106-108, end gasket 110, and cup gasket 112 (i.e., cup gasket mouth 113) provide a 1/32″ seal around the outer circumference of rotatable element 104. When inserted into a channel for a fuel container that is approximately ⅝″ in diameter, gaskets 106-108, end gasket 110, and cup gasket 112 provide a seal that permits a one-way flow of gas from a pressurized gas container (not shown), through adaptive pressure manifold 100 to a fuel cylinder (also not shown). In other examples, the above-referenced parameters and measurements may be varied and are not limited to the examples provided.

In some examples, adaptive pressure manifold 100 may be operated to compensate for various barometric pressures at different altitudes to ensure fuel flow. The amount of inert gas transmitted through adaptive pressure manifold 100 may be varied by rotating a pressurized gas container to contact piercing needle 128 and open one-way check valve 122 when more gas is desired. Alternatively, a pressurized gas container may be rotated in an opposite direction to allow one-way check valve 122 to close by rotating the pressurized gas container away from piercing needle 128. Threads 130 in inlet 124 and gasket 126 provide a seal to ensure that gas does not escape when a pressurized gas container is partially rotated outwards from inlet 124. Further gas is also prevented from escaping or passing into passage 120 by one-way check valve 122. Further, adaptive pressure manifold 100 and the above-described elements may be implemented or used differently and are not limited to the examples provided.

FIG. 1B illustrates a frontal view of an exemplary adaptive pressure manifold. Here, body 102, cup gasket 112, nozzle 114, inlet 124, and nozzle opening 142 are shown. In some examples, body 102, cup gasket 112, and nozzle 114 may be used and implemented as described above in connection with FIG. 1A. In other examples, body 102, cup gasket 112, and nozzle 114 may be implemented differently. For example, body 102 may be coated or formed with a protective external surface to prevent skin burns when using adaptive pressure manifold 140. In other words, when pressurized gas is admitted to adaptive pressure manifold 140, ice or frost may form and result in burns to fingertips or other bodily contact. However, by coating the surface of body 102 with plastic, rubber, or other insulating materials, the cooling effects of high pressure gas flow through adaptive pressure manifold 140 may be minimized. Further, when a pressurized gas container is coupled to inlet 124, pressurized gas may flow through adaptive pressure manifold 140 and exit at nozzle opening 142 and into a fuel container (not shown). In other examples, adaptive pressure manifold 140 and the above-described elements may be varied in design, function, and implementation and are not limited to the examples shown above.

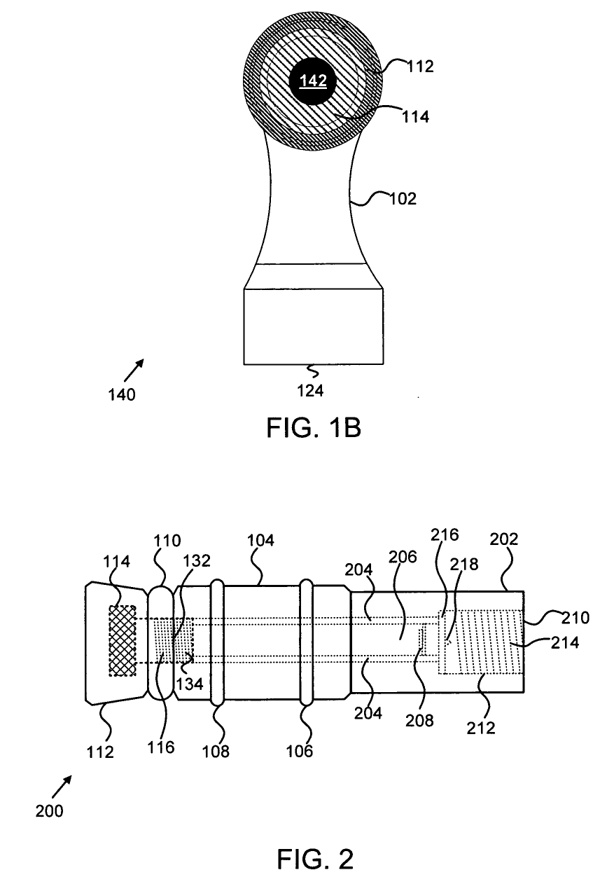

FIG. 2 illustrates a side view of an alternative exemplary adaptive pressure manifold. Here, adaptive pressure manifold 200 includes body 202, passage walls 204, passage 206, one-way check valve 208, inlet opening 210, inlet 212, inlet threads 214, inlet gasket 216, and piercing needle 218. Also, rotatable element 104, gaskets 106-108, end gasket 110, cup gasket 112, nozzle 114, and nozzle threads 116 may be implemented as described above in connection with FIG. 1A. In some examples, a bend or elbow in body 202 may be eliminated, thus implemented passage 206 as a substantially straight channel between inlet 212 and outlet 132. A pressurized gas container (not shown) may be coupled to inlet 212 by engaging inlet threads 214 with threads disposed about the neck of the pressurized gas container (also not shown). When rotated, the pressurized gas container is advanced towards piercing needle 218 until a seal is broken in the neck of the pressurized gas container, thus admitting pressurized gas into passage 206. In some examples, when contact is made between piercing needle 218 and the pressurized gas container, one-way check valve 208 may lift or open into passage 206 to admit pressurized gas. Alternatively, when a pressurized gas container is advanced to and engaged with piercing needle 218, pressurized gas may not flow into passage 206. However, gas is admitted when the pressurized gas container is rotated or backed away from piercing needle 218. Inlet threads 214 and one-way check valve 208 provide a seal that prevents gas from either entering passage 206 or escaping through inlet 210. In other examples, the shape, configuration (e.g., length, width, number of one-way check valves, and the like), parameters, measurements, and other characteristics may be varied in adaptive pressure manifolds 100 (FIG. 1A), 140 (FIG. 1B), and 200 (FIG. 2) and are not limited to the examples provided above. For example, body 102 (FIGS. 1A-1B) and 202 (FIG. 2) may be implemented with different shapes, angles, bends, or “elbows” of varying degrees.

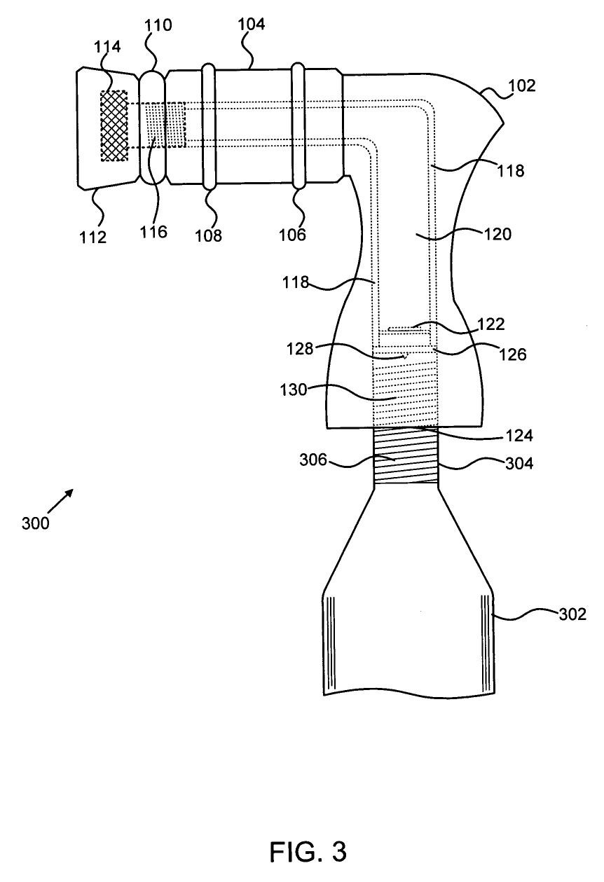

FIG. 3 illustrates another side view of an exemplary adaptive pressure manifold coupled to a pressurized gas container. Here, adaptive pressure manifold system 300 is shown, including body 102, rotatable element 104, gaskets 106-108, end gasket 110, cup gasket 112, nozzle 114, nozzle threads 116, passage walls 118, passage 120, one-way check valve 122, inlet 124, inlet gasket 126, piercing needle 128, inlet threads 130, outlet 132, outlet threads 134, pressurized gas container 302, neck 304, and threads 306. As described above in connection with FIGS. 1A-1B and 2, pressurized gas container 302 may be inserted into inlet 124. In some examples, pressurized gas container 302 may be a cylindrical container made of various types of materials and configured to hold various types of inert gases. For example, pressurized gas container 302 may be made of steel, aluminum, alloys, composite materials, or other metals that provide sufficient tensile strength to withstand forces generated by pressurized gases that may vary from 1 to several hundred pounds-per-square inch (psi), depending upon the volume of space required for filling. Here, discrete amounts of pressurized gases may be released from pressurized gas container 302, flow through adaptive pressure manifold 300 (i.e., passage 120) and into a fuel container (not shown). Inert gases may be used to provide expanding pressure as a motive force for fuel flow from a fuel container without creating risk of either a combustible explosion or aerosol-based flammable mixture. In other examples, pressurized gas container 302 may be implemented differently and is not limited to the examples provided herein.

In some examples, when pressurized gas container 302 is rotated in a first direction (e.g., clockwise), the pressurized gas container 302 advances further into inlet 124. Neck 304 is sealed with the sides or walls (“sides”) of inlet 124 by threads 306. As pressurized gas container 302 is rotated and advanced into inlet 124, a seal is formed and augmented as threads on neck 304 are engaged with threads 306.

In some examples, pressurized gas container 302 may be advanced into inlet 124 until the top (not shown) of neck 304 contacts and is pierced by piercing needle 128. When penetrated, the top of neck 304 permits pressurized gas to escape from pressurized gas container 302 into inlet 124 past inlet gasket 126 and piercing needle 128 and through one-way check valve 122 into passage 120. Passage 120 provides a fluid communication path for gas to transit from one-way check valve 122 to nozzle 114 and out from adaptive pressure manifold 300 and into a fuel container (not shown). Once a desired amount of gas has been released, pressurized gas container 302 may be rotated in a direction opposite to the direction of rotation for advancing pressurized gas container 302 into inlet 124. In other words, if pressurized gas container 302 is advanced into inlet 124 by applying clockwise rotational force, pressurized gas container 302 may be withdrawn or backed out from inlet 124 by applying counterclockwise rotational force. In some examples, by advancing pressurized gas container 302 into inlet 124, gas may be released upon penetration by piercing needle 128. In other examples, gas may not be released until pressurized gas container 302 is penetrated first by piercing needle 128 and then partially withdrawn to allow gas to egress from a puncture and around piercing needle 128. In still other examples, when gas is emitted from pressurized gas container 302, force exerted by the expanding gas lifts or opens one-way check valve 122, thus permitting pressurized gas to further expand into passage 120 and towards and through nozzle 114. Adaptive pressure manifold 300 may be coupled to pressurized gas container 302 differently. Further, adaptive pressure manifold 300 may be implemented, configured, or use differently and is not limited to the examples described above.

FIG. 4 illustrates a side view of an exemplary adaptive pressurized fuel system. Here, adaptive pressurized fuel system 400 is shown, including body 102, rotatable element 104, gaskets 106-108, end gasket 110, cup gasket 112, nozzle 114, nozzle threads 116, passage walls 118, passage 120, one-way check valve 122, inlet 124, inlet gasket 126, piercing needle 128, inlet threads 130, outlet 132, outlet threads 134, pressurized gas container 302, neck 304, threads 306, fuel container 402, fuel container neck 404, insertion channel 406, fuel assembly platform 408, thumbwheel 410, thumbwheel shaft 412, thumbwheel housing 414, fuel supply connection 416, and fuel supply opening 418. In some examples, fuel container 402 may be a fuel bottle such as those provided by Mountain Safety Research (MSR) of Seattle, Wash. In other examples, other types of fuel cylinders, bottles, holders, or containers may be used to implement fuel container 402, which is not limited to the examples provided herein.

In some examples, adaptive pressure manifold 100 (FIG. 1A), 140 (FIG. 1B), 200 (FIG. 2) and others may be used to increase the internal pressure of fuel container 402, thus enabling fuel to flow through fuel supply connection 418 to a coupling with a stove, lantern, lamp, heater, or the like. Thumbwheel 410 may be used to control fuel flow supply volume emitted through fuel supply opening 418. For example, when pressurized gas is released from pressurized gas container 302 through passage 120 and into fuel container 402, a one-way check valve (not shown in fuel container 402) prevents pressurized gas or fuel from escaping through insertion channel 406. Further, gaskets 106-108, end gasket 110, and cup gasket 114 also provide a seal between adaptive pressure manifold 100 (FIG. 1) and the inner walls or surfaces of insertion channel 406. Once fuel container 402 has been pressurized, fuel may be released through fuel supply opening 418 and into a coupling, hose, or other connection (not shown) that allows fuel to flow to a heat source (also not shown). Thumbwheel 410 may be used to open or close a valve (e.g., stop, globe, gate, butterfly, and others) that controls the volume of fuel permitted to flow out of fuel container 402 through fuel supply opening 418. Turning thumbwheel 410 in a direction (e.g., clockwise) may open the valve and turning thumbwheel 410 in an opposite direction may close the valve. In other examples, other types of fuel supply valves and fuel flow control systems may be implemented in fuel container 402 and are not limited to the examples shown.

Here, adaptive pressure manifold 100 (FIG. 1) may be used to pressurize fuel container 402 to provide a stable, consistent flow of fuel without using manual or other unstable techniques for pressurization. In some examples, rotatable element 104, gaskets 106-108, end gasket 110, cup gasket 112, and nozzle 114 are placed into insertion channel 406. Gaskets 106-108, end gasket 110, and cup gasket 112 provide a seal with insertion channel 406, which prevents pressurized gas from escaping into the ambient atmosphere. Further, a one-way check valve (not shown) may be implemented in a fuel flow assembly (also not show) used with fuel container 402 and disposed downstream of (i.e., below) nozzle 114 and cup gasket 112. Thus, when pressurized gas is released, gaskets 106-108, end gasket 110, and cup gasket 112 prevent leakage from insertion channel 406 and a one-way check valve may be used to prevent fuel and pressurized gas from escaping fuel container 402. Pressurized gas may be released from pressurized gas container 302 into passage 120 through one-way check valve 122, which travels through nozzle 114 and into fuel container 402. Fuel container 402 may be pressurized by releasing gas from pressurized gas container 302 and then securing the flow of pressurized gas from pressurized gas container 302 (i.e., by partially withdrawing pressurized gas container 302 to stop the flow of pressurized gas). Once pressurized, fuel container 402 may be separated from adaptive pressure manifold 100 (FIG. 1A), which may be withdrawn manually from insertion channel 406. Once fully withdrawn, a dust cap, plunger, or other implement may be used to seal insertion channel 406 to prevent dirt, dust, and other particulate matter from entering fuel container 402.

Once pressurized, fuel container 402 may be placed in a safe and secure position, coupled to a heat source (e.g., stove, lantern, lamp, heater, or the like) and operated, enabling a steady flow of fuel from fuel container 402 to a heat source (not shown). In other examples, the design, implementation, and operation of adaptive pressurized fuel system 400, adaptive pressure manifold 100 (FIG. 1A), and the above-described elements may be varied and are not limited to the examples provided. For example, inlet 124 and pressurized gas container 302 may be implemented without using threads 130 and 306. In still other examples, different types and shapes of nozzles may be used and are not limited to the examples shown. Further, different fuel containers other than fuel container 402 may be used and are not limited to the examples shown and described.

Although the foregoing examples have been described in detail for purposes of clarity of understanding, certain changes and modifications may be practiced within the scope of the appended claims. Accordingly, the present examples are to be considered as illustrative and not restrictive, and not limited to the details given herein and may be modified within the scope and equivalents of the appended claims. In the claims, elements and/or steps do not imply any particular order of operation, unless explicitly stated in the claims.

What is claimed is:

1. An adaptive pressure manifold, comprising:
a body having an inlet adapted to receive a pressurized gas container at a proximal end of the body, wherein a passage is provided within the body between the inlet and an outlet located on a distal end of the body;
a rotatable element axially coupled to the distal end of the body, the rotatable element having one or more circumferential trenches configured to receive one or more gaskets; and
an end gasket axially disposed between a distal end of the rotatable element and a cup gasket, the cup gasket and the end gasket being secured to the rotatable element by a threaded nozzle having a plurality of threads disposed at a proximal end, the plurality of threads being received by the outlet.

2. The adaptive pressure manifold of claim 1, wherein the passage further comprises a one-way check valve preventing gas from flowing from the outlet to the inlet.

3. The adaptive pressure manifold of claim 1, wherein the inlet further comprises a threaded surface, the threaded surface being used to couple the body to the pressurized gas container.

4. The adaptive pressure manifold of claim 1, wherein the passage provides fluid communication between the inlet and the outlet.

5. The adaptive pressure manifold of claim 1, wherein an external surface of the rotatable element is substantially smooth.

6. The adaptive pressure manifold of claim 1, wherein the one or more gaskets, the end gasket, and the cup gasket provide a seal between an outer surface of the rotatable element and an internal surface of a channel within a fuel container.

7. The adaptive pressure manifold of claim 1, wherein the one or more gaskets, the end gasket, and the cup gasket provide a seal with an internal surface of a channel within a fuel container, the rotatable element being configured for insertion into the channel.

8. An adaptive pressure manifold, comprising:
a body having an inlet adapted to receive a pressurized gas container at a proximal end of the body, wherein a passage provides fluid communication between the inlet and an outlet located on a distal end of the body;
a rotatable element coupled to the distal end of the body, the rotatable element having a groove disposed about the circumference of the rotatable element and substantially orthogonal to an axis of the rotatable element, the groove being configured to receive a gasket; and
an end gasket disposed between a distal end of the rotatable element and a cup gasket, the cup gasket and the end gasket being secured to the rotatable element by a nozzle having a plurality of threads disposed at a proximal end, the proximal end being secured within the outlet using the plurality of threads.

9. The adaptive pressure manifold of claim 8, wherein the pressurized gas container houses an inert gas.

10. The adaptive pressure manifold of claim 9, wherein the inert gas is carbon dioxide.

11. The adaptive pressure manifold of claim 9, wherein the inert gas is helium.

12. The adaptive pressure manifold of claim 8, wherein the inlet further comprises a piercing needle configured to puncture a seal in the pressurized gas container.

13. The adaptive pressure manifold of claim 8, wherein the gasket, the end gasket, and the cup gasket are configured to provide a seal with an inner surface of a channel within a fuel container.

14. The adaptive pressure manifold of claim 8, wherein a proximal end of the cup gasket has a first radius that is less than a second radius of a distal end of the cup gasket.

15. The adaptive pressure manifold of claim 8, wherein an outer surface of a proximal end of the cup gasket provides a seal with an inner surface of a channel, the seal being used to prevent gas from flowing between the rotatable element and the inner surface of the channel.

16. An adaptive pressurized fuel system, comprising:
a body having an inlet adapted to receive a pressurized gas container at a proximal end of the body, wherein a passage provides fluid communication between the inlet and an outlet located on a distal end of the body;
a rotatable element axially coupled to the distal end of the body, the rotatable element having a groove disposed about the circumference of the rotatable element and orthogonal to an axis of the rotatable element, the groove being configured to receive a gasket, wherein the rotatable element is inserted into a channel within a fuel container, the gasket providing a seal with an internal surface of the channel; and
an end gasket disposed between a distal end of the rotatable element and a cup gasket, the cup gasket and the end gasket being secured to the rotatable element by a nozzle having a plurality of threads disposed at a proximal end, the plurality of threads being configured to secure the nozzle within the outlet, the cup gasket, and the end gasket to the outlet, wherein gas from the pressurized gas cylinder flows through the passage to the nozzle and into the fuel container, the gas being used to increase air pressure within the fuel container to provide a flow of fuel from the fuel container to a heat source.
